(19) United States
(12) Patent Application Publication
(10) Pub. No.: US 2013/0027389 A1
(43) Pub. Date: Jan. 31, 2013

(54) MAKING A TWO-DIMENSIONAL IMAGE INTO THREE DIMENSIONS

(71) Applicant: ZHE WANG, BEIJING (CN)

(72) Inventor: ZHE WANG, BEIJING (CN)

(73) Assignee: INTERNATIONAL BUSINESS MACHINES CORPORATION, ARMONK, NY (US)

(21) Appl. No.: 13/477,308

(22) Filed: May 22, 2012

(30) Foreign Application Priority Data
Jul. 27, 2011 (CN) 201110219144.2

(51) Int. Cl. G06T 15/00

(52) U.S. Cl. 345/419

(57) ABSTRACT

A 2D (two dimensional) image can be received that comprises at least one image layer. A depth value can be added to the image layer in the 2D image. The 2D image can be made into 3D (three dimensional) by using the added depth value.

### CROSS REFERENCE TO RELATED APPLICATIONS

This application claims priority of Chinese Application No. 201110219144.2 entitled “MAKING A 2D IMAGE INTO 3D”, filed on Jul. 27, 2011.

### BACKGROUND

The present invention relates to a method, system, and program for making a 2D image into 3D.

Currently, technology of image layering is used by image processing software and document presentation software. Image processing software that applies the image layer technology includes, for example, Photoshop (product and registered trademark of Adobe), Auto CAD (product and registered trademark of Autodesk) and etc., while document presentation software includes, for example, PowerPoint (product and registered trademark of Microsoft), Lotus Symphony (product and registered trademark of IBM), Open Office (product and registered trademark of Oracle) and so on.

All layers and the images formed by multiple image layers used by conventional image processing software and presentation software are two-dimensional (2D).

### BRIEF SUMMARY

According to one aspect of the present invention, a method for making a 2D image into 3D is provided, comprising: receiving a 2D image that comprises at least one image layer; adding a depth value to the image layers in the 2D image; and making the 2D image into 3D by using the added depth value.

According to another aspect of the present invention, a system for making a 2D image into 3D is provided, comprising: 2D image receiving means configured to receive a 2D image that comprises at least one image layer; depth value adding means configured to add a depth value to the image layer in the 2D image; and 3D rendering means configured to make the 2D image into 3D by using the added depth value.

According to the method and system of the present invention, by adding a depth value to the image layers in a 2D image and rendering the 2D image with the depth value being added based on a known 3D imaging principle, the 2D image formed by image layers may be quickly and conveniently made into 3D with the image layers as basic units, without the need of modifying the image layers of the original 2D image or the need of calculating the 3D location information for each pixel in the original 2D image one by one.

### BRIEF DESCRIPTION OF THE SEVERAL VIEWS OF THE DRAWINGS

FIG. 1 illustrates a block diagram of an exemplary computing system that is adapted to implement the embodiments of the present invention.

FIG. 2 illustrates a flow chart of a method for making a two-dimensional (2D) image into three dimensions (3D) according to an embodiment of the present invention.

FIG. 3A illustrates a diagram of a 2D image according to one embodiment of the present invention.

FIG. 3B illustrates an effect diagram of an image layer with the depth value being added in the 2D image in FIG. 3A according to one embodiment of the present invention.

FIG. 4 illustrates a block diagram of a system for making a 2D image into 3D according to one embodiment of the present invention.

FIG. 5A illustrates diagrams of different view angles of left and right eyes;

FIG. 5B illustrates a diagram of a method of displaying a 3D planar image (2D image added with the depth value).

FIGS. 5C and 5D illustrate the left and right eye views obtained in a manner of FIG. 5B.

FIG. 5E illustrates a final 3D image obtained after superposing the left and right views of FIGS. 5C and 5D.

### DETAILED DESCRIPTION

An image layer is like a film that contains elements such as words or images, and a final effect of a page is formed by superposing each piece of film one by one. The image layer may accurately locate the elements on the page. Texts, pictures, tables, and plug-ins may be added into the image layer, or an image layer may be embedded therein. For example, a two-dimensional (2D) image with a layer relationship has a plurality of images in its different layers, just like each image being drawn on an individual piece of transparent paper, and then superposing all pieces of paper to form this complete image. Thus, the layer has the following constraints: (1) the image on an upper layer may always block all images on each lower layer; (2) the number of layers is not limited, namely, there may be infinite number of layers; and (3) the layers cannot be interpenetrated (i.e., no two layers that block each other exist).

Although the image layer technology is widely applied in much image processing software and document presentation software, all layers and the images formed by multiple image layers are two-dimensional. However, it is more desirable for users to be capable of editing or viewing three-dimensional (3D) images (or presentation documents), so as to achieve a more realistic and vivid user experience.

The prior art has proposed some technical solutions for making 3D images or generating a 3D image based on a 2D image. For example, for the widely applied 3D film, its making process mainly comprises: shooting simultaneously by two parallel placed video cameras to simulate left and right human eyes during shooting respectively, and finally superposing them together when playing or editing, such that viewers may enjoy a 3D effect via 3D glasses (the left eye can only see the left image, and the right eye can only see the right image). As another example, the prior art also proposes a technical solution of converting a common 2D image into a 3D image, the key point of which lies in the need of a complex algorithm to calculate the distance of each pixel in each frame of picture in a 2D image with respect to other pixels. Because the amount of pixels in each frame of 2D image is considerable, it causes the increase of complexity of the algorithm and the overwhelmingly great computational load.

Thus, although the 3D imaging principle and technology have been rather mature, the prior art does not provide any technical solution that may utilize the image layers in an existing 2D image to conveniently and quickly convert the 2D image into a 3D image.

In view of the above problems, embodiments of the present invention propose solutions that provide a method and system for making a 2D image formed by image layers into 3D. Another embodiment of the present invention provides a method and system for making a 2D image into 3D without modifying the image layers in the 2D image. A yet another embodiment of the present invention provides a method and system for making an entire 2D image into 3D with image layers as basic units without calculating each pixel in the 2D image one by one.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

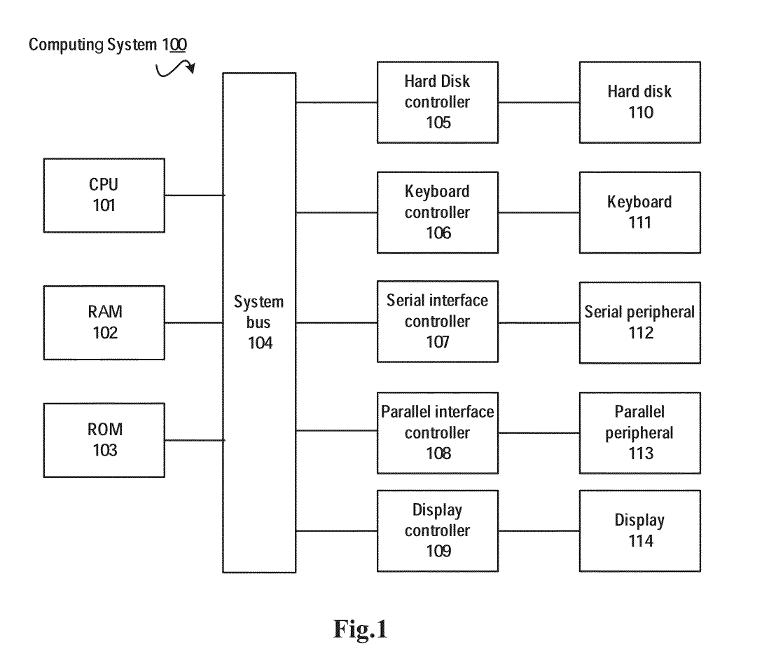

FIG. 1 illustrates a block diagram of an exemplary computing system 100 that is adapted to implement the embodiments of the present invention. As shown, the computer system 100 may comprise: a CPU (Central Processing Unit) 101, a RAM (Random Access Memory) 102, a ROM (Read Only Memory) 103, a system bus 104, a hard disk controller 105, a keyboard controller 106, a serial interface controller 107, a parallel interface controller 108, a display controller 109, a hard disk 110, a keyboard 111, a serial peripheral 112, a parallel peripheral 113 and a display 114. Among these components, coupled to the system bus 104 are the CPU 101, the RAM 102, the ROM 103, the hard disk controller 105, the keyboard controller 106, the serial interface controller 107, the parallel interface controller 108 and the display controller 109. The hard disk 110 is coupled to the hard disk controller 105; the keyboard 111 is coupled to the keyboard controller 106; the serial peripheral 112 is coupled to the serial interface controller 107; the parallel peripheral 113 is coupled to the parallel interface controller 108; and the display 114 is coupled to the display controller 109. It should be appreciated that the structural block diagram of FIG. 1 is shown only for illustration, and is not intended to limit the scope of the present invention. In some cases, some devices may be added or reduced according to specific circumstances.

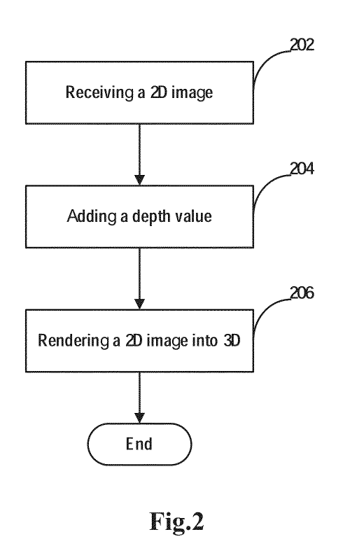

FIG. 2 illustrates a flow chart of a method for making a 2D image into 3D according to an embodiment of the present invention. The method of FIG. 2 starts from step 202. At step 202, a 2D image that comprises at least one image layer is received. According to one embodiment of the present invention, the 2D image is a presentation document, such as PowerPoint document, Lotus Symphony document, or Open Office document. According to another embodiment of the present invention, a 2D image is a picture generated in an image processing software such as Photoshop. Regardless of the specific file type and format of a 2D image, as long as it is composed of one or more image layers, it may be used to achieve the objective of the present invention (i.e., making a 2D image that comprises at least one image layer into 3D). It should be noted that in some cases, the background of a 2D image is not an independent image layer. In such case, even if the 2D image merely comprises one image layer, it may be made into 3D (with respect to the background).

In one embodiment, the method of FIG. 2 proceeds to step 204 where a depth value is added to the image layer of the received 2D image. Because the 2D image only has size information in two dimensions (length and width) in a plane, the size information on the third dimension in space must be given to the 2D image so as to make the 2D image into 3D. According to one embodiment of the present invention, the depth value represents the distance between the image layer and the screen (which may also be appreciated as the distance from the image layer to the background, because the background and the screen are always in a same plane). According to another embodiment of the present invention, the depth value represents the relative distance between the image layer and other image layer. According to yet another embodiment of the present invention, the depth value represents the distance between the image layer and the observer. The depth value may be added for each image layer in a 2D image or added to some image layers in the 2D image. Suppose a 2D image is merely composed of two image layers. If only one image layer thereof is added with a depth value, then the other image layer may be deemed as no depth in default (i.e., the depth value is 0). As to the unit of depth value, according to one embodiment of the present invention, the length and width size units on the 2D image plane may be directly utilized (different image processing software or presentation document software have different size units), or a spatial depth (third dimension)-based size unit may be specially set.

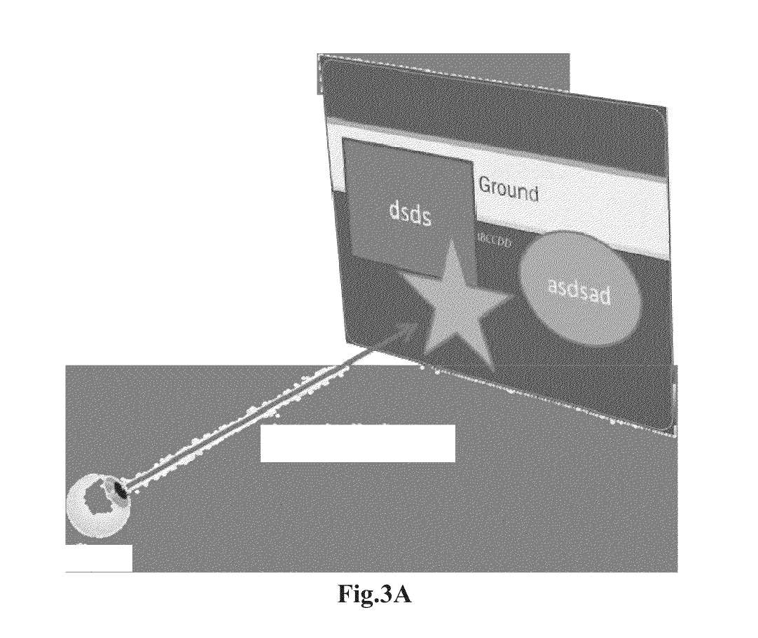

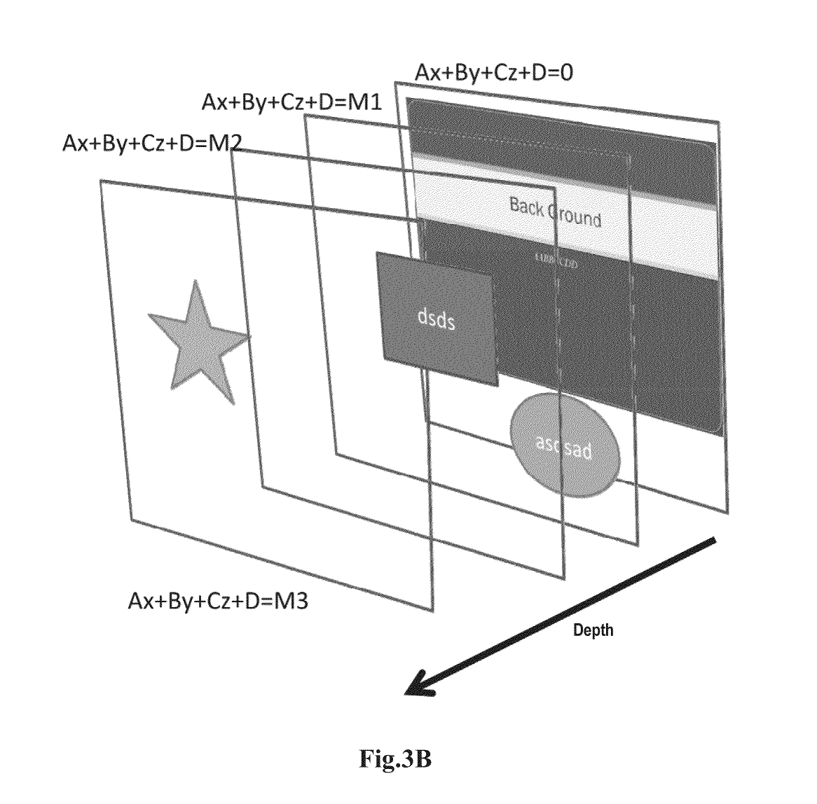

According to one embodiment of the present invention, the manner of adding a depth value to the image layer in a 2D image is specified below: first, placing an original 2D image that has layer information in a 3D space, where at this point, the 2D image is a rectangular plane that has borders in the 3D space, whose spatial stereo geometry equation is Ax+By+Cz+D=0 Likewise, the image on each layer thereof may be deemed as on an individual plane; currently, all the image layer planes are superposed with the plane of the 2D image. Namely, their spatial stereo geometry equations are all Ax+By+Cz+D=0. And then let a graph on a layer of the 2D image move a certain distance M along a normal direction (A, B, C) of this plane, where the spatial stereo geometry equation of its plane is Ax+By+Cz+D=M Likewise, the graph on each layer may be moved along the normal direction (A, B, C) of this plane, but the moved distance may be different. Then, each layer has a different spatial stereo geometry equation. Thus, in actual calculation, as long as the space stereo equation of the 2D image Ax+By+Cz+D=0 is obtained, different plane equations may be obtained by modifying for each layer the D value of its plane equation. Namely, each layer is disposed in a plane that is parallel to the original 2D image with a distance not being zero, and these planes are all in one 3D space; at this point, it may be deemed that the entirety formed by these planes has 3D information. Their distance from the plane where the original 2D image is located is the “depth value.” FIGS. 3A and 3B illustrate diagrams of the above method of adding a depth value.

Those skilled in the art should understand, because the 2D image might have different parameter representation manners or manners of granting values for size information in different image processing software or presentation software environments, those skilled in the art may perform the operation of granting the depth value for a 2D image under different software or application based on the above principle. Regardless of the specific steps of granting the depth values for the image layers in the 2D image, as long as the depth value is added to the image layers in the 2D image, it falls into the protection scope of the present invention.

Because the operation of adding the depth value in step 204 is performed for the image layers in a 2D image, all pixel points on each image layer have a same depth value, without the need of calculating the spatial relative position information of each pixel point with respect to other pixel points like in the prior art.

It should also be noted that according to one embodiment of the present invention, different default depth values may be set for the image layers at respective level in the 2D image, and the default depth value as set is independent of the specific 2D image. As long as the user activates the 3D operation for a specific 2D image, the preset default depth value is automatically added to each image layer of the specific 2D image. According to another embodiment of the present invention, a real-time specified depth value (which may replace the default depth value, or be directly specified in real time in case of no preset default depth value) may be received in the process of making a specific 2D image into 3D. The content of these two embodiments will be explicitly embodied below.

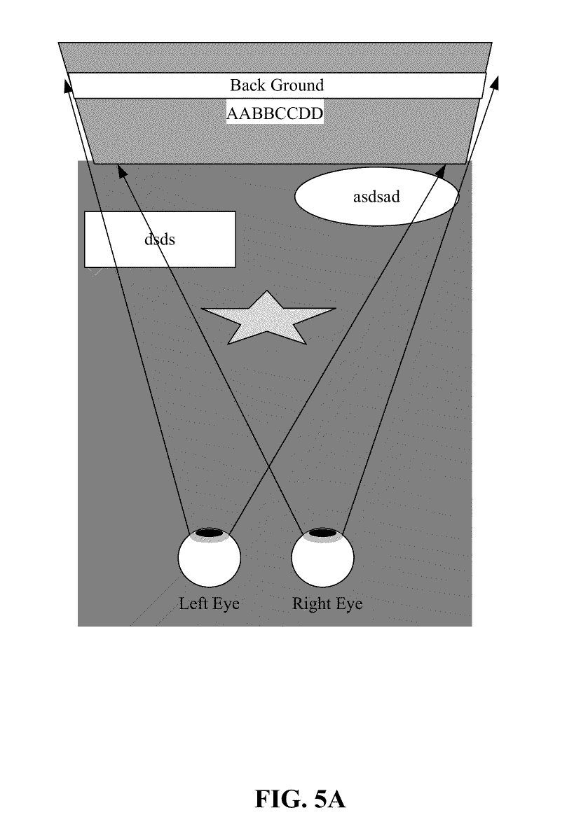

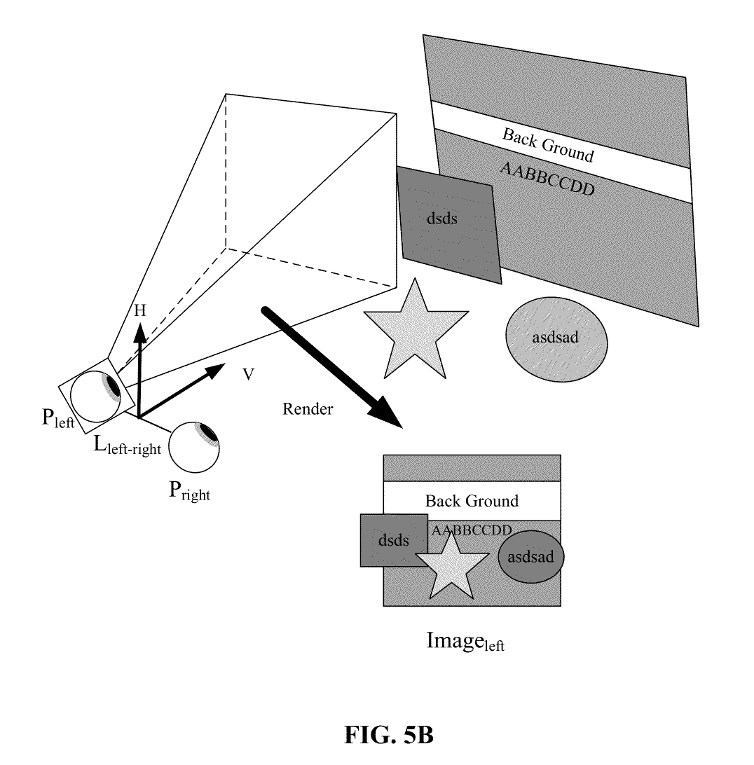

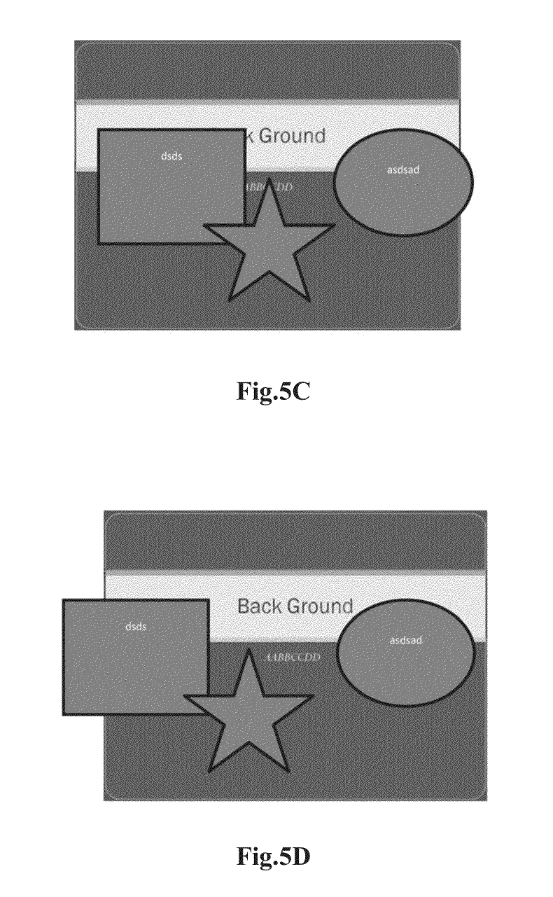

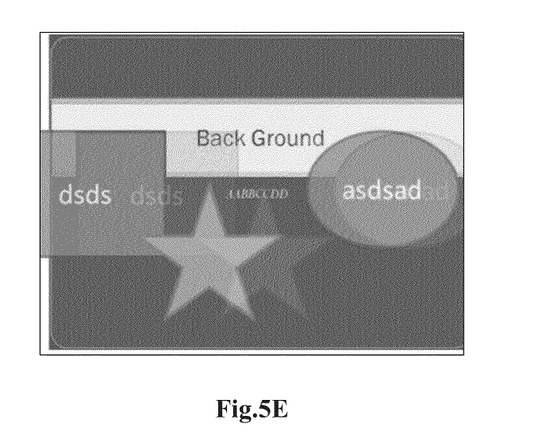

The method as shown in FIG. 2 proceeds to step 206. At step 204, the image layer of the 2D image has been added with the depth value, such that the 2D image has comprehensive 3D information, but it does not mean the 3D image has been generated. The operation of step 206 is performed just for making the 2D image into 3D by using the added depth value (i.e., rendering the 2D image with the depth value having been added to be a 3D image). Those skilled in the art should understand, in the case of having comprehensive 3D information of the image, rendering the 2D image into the final 3D image may be implemented by generating two 2D images of the left and right eyes and then superposing the two 2D images, which belongs to common knowledge in the art. Even so, the method of rendering a 3D image is still introduced in FIG. 5.

According to the method shown in FIG. 2, because of adding a depth value to the image layer in a 2D image and rendering the 2D image with the depth value being added based on a known 3D imaging principle, the 2D image formed by image layers may be quickly and conveniently made into 3D with the image layer as basic units, without the need of modifying the image layer of the original 2D image or the need of calculating the 3D location information for each pixel in the original 2D image one by one.

According to one embodiment of the present invention, adding a depth value to the image layer of a received 2D image at step 204 comprises adding a corresponding default depth value to the image layer in the 2D image, wherein the default depth value is preset for the image level of the 2D image. At this point, the preset default depth value is not for a specific 2D image.

According to another embodiment of the present invention, adding a depth value to the image layer of a received 2D image at step 204 comprises adding a real-time specified depth value for the image layer of the 2D image. In other words, even if there is a preset default depth value, the user may have different rendering requirements on a specific 2D image, thus it is possible to perform customized setting or adjustment for the depth value.

According to one embodiment of the present invention, making the 2D image into 3D by using the added depth value at step 206 comprises generating two 2D images with respect to the two eyes of a observer from the 2D image that comprises the image layer with the depth value added by using a 3D geometry matching algorithm, such that the generated two 2D images are combined into a 3D image. It should be noted that those skilled in the art may employ a plurality of 3D image rendering manner. In the case of having obtained comprehensive 3D information (depth value) of the 2D image, regardless of using what manner to render the 2D image into a 3D image, it falls within the protection scope of the present invention. It should also be noted that the two 2D images with respect to the two eyes of the observer may be first stored respectively, so as to combine them into a 3D image when presenting or playing, or the two 2D images may be directly combined to generate a 3D image.

FIG. 3A illustrates a diagram of a 2D image according to one embodiment of the present invention. The 2D image in FIG. 3A comprises 4 image layers, where the first image layer is a background image layer marked as “Back Ground,” the second image layer is an oval image layer marked as “ascsad,” the third image layer is a rectangular image layer marked as “dsds,” and the fourth image layer is a pentagram image layer without any mark.

FIG. 3B illustrates an effect diagram after adding a depth value to image layers in the 2D image of FIG. 3A. It can be seen from FIG. 3 that the spatial stereo geometry equation for the background image layer marked as “Back ground” with depth value being added is Ax+By+Cz=0; the spatial stereo geometry equation for the oval image layer marked as “ascsad” with depth value being added is Ax+By+Cz=M1; the spatial stereo geometry equation for the rectangular image layer marked as “dsds” with depth value being added is Ax+By+Cz=M2; and the spatial stereo geometry equation for the pentagram image layer without any mark with depth value being added is Ax+By+Cz=M3. Because M1≠M2≠M3≠0, the four image layers with depth values being added in the 2D image are distinct in spatial depth. It should be noted that the stereo effect cannot be immediately presented just after adding the depth value for each image layer, and the stereo perspective effect as illustrated in FIG. 3B is only for the purpose and effect of illustrating adding depth values.

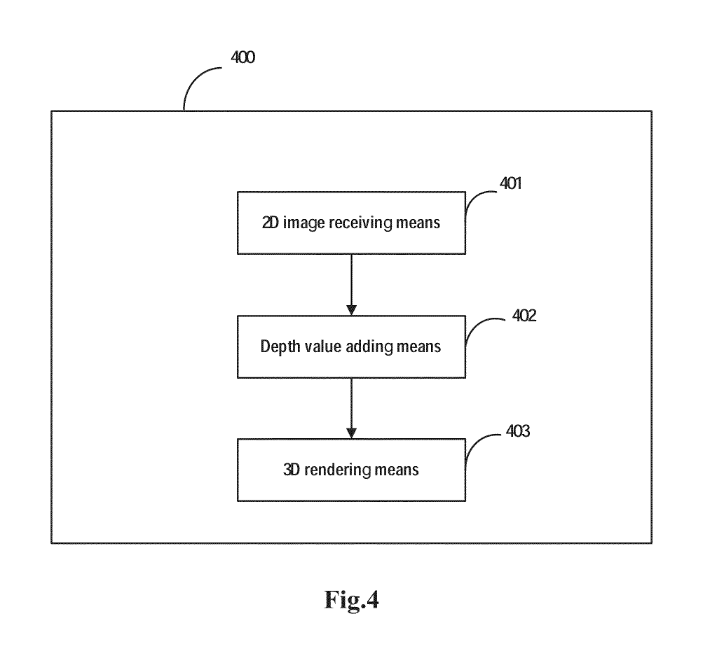

FIG. 4 illustrates a block diagram of a system for making a 2D image into 3D according to one embodiment of the present invention. The system as shown in FIG. 4 is generally expressed by system 400. Specifically, the system 400 comprises a 2D image receiving means 401 configured to receive a 2D image that comprises at least one image layer; a depth value adding means 402 configured to add a depth value to the image layer in the 2D image; and a 3D rendering means 403 configured to render the 2D image into 3D by using the added depth value. Those skilled in the art should understand that the means 401-403 in the system 400 correspond to steps 202, 204, and 206 in the method as shown in FIG. 2, which will not be detailed here.

Hereinafter, the method of rendering a 2D image that already has spatial depth information to be a 3D stereo image (i.e., a 3D geometry matching algorithm) will be illustrated specifically with reference to FIGS. 5A to 5E.

FIG. 5A illustrates diagrams of different view angles of left and right eyes. It can be seen from FIG. 5A that for a same stereo object, the views perceived by human left eye and right eye are different. It is also the basis and basic principle of rendering a 3D stereo image.

FIG. 5B illustrates a diagram of a method of displaying a 3D planar image (i.e., a 2D image with the depth value being added). It can be seen from FIG. 5B that points P_{left} and P_{right} at two different positions are set in the 3D space where the four image layers are located, representing the human left and right eyes respectively, and the connection line between the two points is the vector L_{left-right}. Then, a vector H(x, y, z) vertical to L_{left-right} is set to represent a direction of human head upward. Again a vector V(xn, yn, zn) is set, and V is vertical to the plane composed of H and L_{left-right}. V represents the direction of the view angles of human eyes. Then, with points P_{left} and P_{right} as base points, H as the upward direction, and V as view cone direction, two 3D projection view cones are established. By the 3D cone transformation method in the fundamentals of computing graphics, the 3D planes of the 2D image are rendered out through the two 3D projection view cones respectively, with a 2D image being obtained from each view cone, representing the 2D images that may be perceived by the left and right eyes, respectively, set to be Image_{left} and Image_{right}.

FIGS. 5C and 5D illustrate the left and right eyes views Image_{left} and Image_{right} obtained according to the manner shown in FIG. 5B respectively.

Next, the two 2D images are superposed and outputted to a 3D display device to display the final 3D effect. The 3D display device referred to here may guarantee that when a person is watching, the left eye can only see the Image_{left}, and the right eye can only see the Image_{right}. For example, for an active stereo display, it is equipped with active stereo glasses. The two images Image_{left} and Image_{right} are alternately displayed on the display, and meanwhile signals are sent to the active stereo glass for polarization block of the lenses. When the display displays Image_{left}, the left lens of the active stereo glasses is allowed to perceive the image, while the right lens cannot perceive any image due to polarization block. Also, when the display displays Image_{right}, the right lens of the active stereo glasses is allowed to perceive the image, while the left lens cannot perceive any image due to polarization block. When the alternation frequency is above 60 times per second, human eyes cannot sense the block effect of each lens, and they merely see the image that can only be perceived by each lens, such that it guarantees that the left eye can always only see Image_{left}, while the right eye can always only see Image_{right}. FIG. 5E illustrates a final 3D image after superposing the left and right views of FIGS. 5C and 5D. The final 3D stereo effect may be presented into eyes of a viewer wearing suitable 3D glasses.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
receiving a 2D (two dimensional) image that comprises at least one image layer;
adding a depth value to the image layer in the 2D image; and
making the 2D image into 3D (three dimensional) by using the added depth value, wherein at least one of the receiving, adding, and making is carried out using a computing device.

2. The method of claim 1, wherein adding the depth value to the image layer in the 2D image comprises:
adding a corresponding default depth value to the image layer in the 2D image, wherein the default depth value is preset for the image layer of the 2D image.

3. The method of claim 1, wherein adding the depth value to the image layer in the 2D image comprises:
adding a depth value that is specified in real time to the image layer in the 2D image.

4. The method of claim 1, wherein making the 2D image into 3D by using the added depth value comprises:
generating two 2D images with respect to two eyes of the observer from a 2D image that has an image layer added with a depth value by using a 3D geometry matching algorithm, so as to combine the generated two 2D images into a 3D image.

5. The method of claim 1, wherein the depth value of the image layer represents a distance between the image layer and a screen.

6. The method of claim 1, wherein the depth value of the image layer represents a relative distance between the image layer and other image layers.

7. The method of claim 1, wherein the depth value of the image layer represents a distance between the image layer and an observer.

8. A computer program product comprising:
one or more computer-readable storage devices;
program instructions, stored on at least one of the one or more storage devices, to receive a 2D (two dimensional) image that comprises at least one image layer;
program instructions, stored on at least one of the one or more storage devices, to add a depth value to the image layer in the 2D image; and
program instructions, stored on at least one of the one or more storage devices, to make the 2D image into 3D (three dimensional) by using the added depth value.

9. The computer program product of claim 8, wherein program instructions to add the depth value to the image layer in the 2D image comprise:
program instructions, stored on at least one of the one or more storage devices, to add a corresponding default depth value to the image layer in the 2D image, wherein the default depth value is preset for the image layer of the 2D image.

10. The computer program product of claim 8, wherein program instructions to add the depth value to the image layer in the 2D image comprise:
program instructions, stored on at least one of the one or more storage devices, to add a depth value that is specified in real time to the image layer in the 2D image.

11. The computer program product of claim 8, wherein program instructions to make the 2D image into 3D by using the added depth value comprise:
program instructions, stored on at least one of the one or more storage devices, to generate two 2D images with respect to two eyes of the observer from a 2D image that has an image layer added with a depth value by using a 3D geometry matching algorithm, so as to combine the generated two 2D images into a 3D image.

12. The computer program product of claim 8, wherein the depth value of the image layer represents a distance between the image layer and a screen.

13. The computer program product of claim 8, wherein the depth value of the image layer represents a relative distance between the image layer and other image layers.

14. The computer program product of claim 8, wherein the depth value of the image layer represents a distance between the image layer and an observer.

15. A system comprising:
one or more processors and one or more computer-readable storage devices;
program instructions, stored on at least one of the one or more storage devices for execution by at least one of the one or more processors, to receive a 2D (two dimensional) image that comprises at least one image layer;
program instructions, stored on at least one of the one or more storage devices for execution by at least one of the one or more processors, to add a depth value to the image layer in the 2D image; and
program instructions, stored on at least one of the one or more storage devices for execution by at least one of the one or more processors, to make the 2D image into 3D (three dimensional) by using the added depth value.

16. The system of claim 15, wherein program instructions to add the depth value to the image layer in the 2D image comprise:
program instructions, stored on at least one of the one or more storage devices for execution by at least one of the one or more processors, to add a corresponding default depth value to the image layer in the 2D image, wherein the default depth value is preset for the image layer of the 2D image.

17. The system of claim 15, wherein program instructions to add the depth value to the image layer in the 2D image comprise:
program instructions, stored on at least one of the one or more storage devices for execution by at least one of the one or more processors, to add a depth value that is specified in real time to the image layer in the 2D image.

18. The system of claim 15, wherein program instructions to make the 2D image into 3D by using the added depth value comprise:
program instructions, stored on at least one of the one or more storage devices for execution by at least one of the one or more processors, to generate two 2D images with respect to two eyes of the observer from a 2D image that has an image layer added with a depth value by using a 3D geometry matching algorithm, so as to combine the generated two 2D images into a 3D image.

19. The system of claim 15, wherein the depth value of the image layer represents a distance between the image layer and a screen.

20. The system of claim 15, wherein the depth value of the image layer represents a relative distance between the image layer and other image layers, or wherein the depth value of the image layer represents a distance between the image layer and an observer.
